(19) United States
(12) Patent Application Publication
(10) Pub. No.: US 2008/0037299 A1
(43) Pub. Date: Feb. 14, 2008

(54) METHOD FOR DRIVING DC-AC CONVERTER

(75) Inventors: Sadanori Suzuki, Kariya-shi (JP); Kiminori Ozaki, Kariya-shi (JP)

Correspondence Address: WOODCOCK WASHBURN LLP, CIRA CENTRE, 12TH FLOOR, 2929 ARCH STREET, PHILADELPHIA, PA, 19104-2891, US

(73) Assignee: Kabushiki Kaisha Toyota Jidoshokki, Kariya-shi (JP)

(21) Appl. No.: 11/837,101

(22) Filed: Aug. 10, 2007

(30) Foreign Application Priority Data
Aug. 11, 2006 (JP) 2006-219515

(51) Int. Cl. H02M 1/00

(52) U.S. Cl. 363/49

(57) ABSTRACT

A method for driving a converter that converts DC voltage to AC voltage. A voltage conversion circuit has first input terminals and first output terminals insulated from the first input terminals. A filter circuit has second input terminals and second output terminals. A first switch circuit connects the first output and second input terminals. A second switch circuit connects the first switch circuit and the second input terminals. The method includes supplying the first input terminals with DC voltage, converting the DC voltage to AC voltage and supplying the converted voltage to the first output terminals, supplying the second input terminals with the converted voltage, stopping the supply of the converted voltage, and maintaining the first switch circuit or the second switch circuit in an activated state to output AC voltage from the second output terminals of the filter circuit.

### CROSS-REFERENCE TO RELATED APPLICATIONS

This application is based upon and claims the benefit of priority from the prior Japanese Patent Application No. 2006-219515, filed on Aug. 11, 2006, the entire contents of which are incorporated herein by reference.

### FIELD OF THE INVENTION

The present invention relates to a method for driving a DC-AC converter that converts direct current (DC) voltage to alternating current (AC) voltage.

### BACKGROUND OF THE INVENTION

FIG. 1 is a circuit block diagram of an AC inverter described in Japanese Laid-Open Patent Publication No. 2002-315351. One end of a power supply line 210a is connected to a power supply terminal of a DC input unit 210, such as a battery (e.g., a DC 12 V battery). The other end of the power supply line 210a is connected to a DC input filter 230, which may be formed by a choke coil and a capacitor. A switching circuit 240, which is a push-pull circuit, oscillates DC 12V power from the DC input unit 210 at a frequency of, for example, 55 kHz. The high-frequency oscillation performed by the switching circuit 240 generates a high voltage output (e.g., 140 V) in a high voltage coil of a transformer 250. A DC high-voltage rectifier circuit 260 smoothes the waveform of the high-voltage output. Output voltage of the rectifier circuit 260 is supplied to a drive circuit 280 via a DC output line 260a. The drive circuit 280 (an AC inverter circuit) includes, for example, four FETs (field effect transistors) that are connected in an H-bridge with respect to two AC output lines 280a and 280b. The drive circuit 280 generates an AC voltage of, for example, 55 Hz at the AC output lines 280a and 280b by alternately driving two diagonal FETs at a predetermined duty ratio.

Low DC voltage output from the DC input unit 210 is converted to AC voltage having a high voltage and a low frequency. The AC voltage is then output from the AC output lines 280a and 280b. To obtain AC voltage through the operation of the drive circuit 280, the AC inverter shown in FIG. 1 requires three conversions to be performed, namely, conversion from DC voltage to AC voltage, conversion from AC voltage to DC voltage, and conversion from DC voltage to AC voltage. Thus, the AC inverter is required to execute complicated power conversion control before outputting the desired AC voltage. Further, the AC inverter may increase loss, such as switching loss, in its circuit operation. As a result, the AC inverter may fail to have sufficiently high power conversion efficiency.

### SUMMARY OF THE INVENTION

The present invention provides a method for driving a novel DC-AC converter that directly converts input DC voltage to a desired AC voltage.

One aspect of the present invention is a method for driving a DC-AC converter that converts DC voltage to AC voltage. The DC-AC converter includes a voltage conversion circuit having a pair of first input terminals and a pair of first output terminals insulated from the pair of first input terminals, a filter circuit having a pair of second input terminals and a pair of second output terminals, a first switch circuit arranged between the pair of first output terminals and the pair of second input terminals for operably connecting the voltage conversion circuit and the filter circuit, and a second switch circuit arranged between the first switch circuit and the pair of second input terminals. The method includes the steps of supplying the pair of first input terminals of the voltage conversion circuit with the DC voltage, converting the DC voltage to voltage having a polarity corresponding to the AC voltage with the voltage conversion circuit under a state in which the first switch circuit is activated and supplying the converted voltage to the pair of first output terminals, supplying the pair of second input terminals of the filter circuit with the converted voltage, stopping the supply of the converted voltage from the voltage conversion circuit under a state in which the first switch circuit is activated, and maintaining at least either one of the first switch circuit and the second switch circuit in an activated state so that the AC voltage is output from the pair of second output terminals of the filter circuit.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic circuit block diagram of a conventional AC inverter;

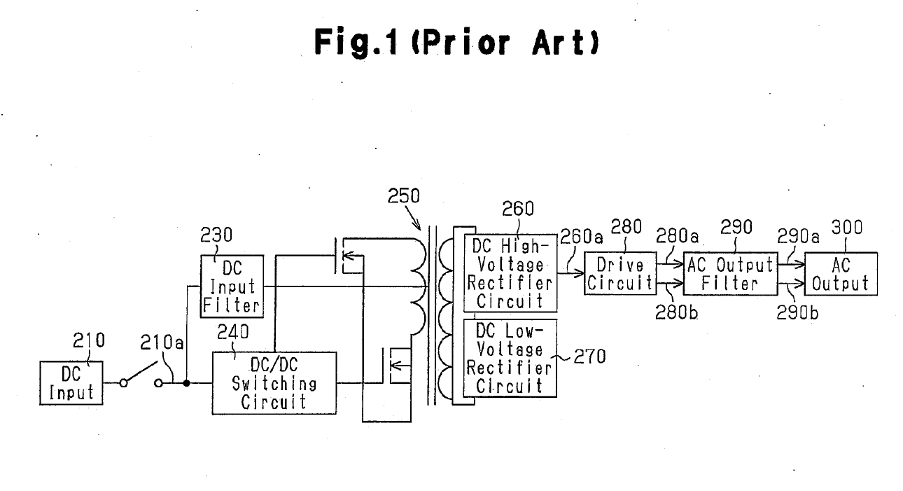

FIG. 2 is a circuit block diagram describing the principle of a DC-AC converter driven by the method of the present invention;

FIG. 3 is a schematic circuit block diagram of a DC-AC converter driven by a method according to a preferred embodiment of the present invention;

FIG. 4 shows the DC-AC converter of FIG. 3 in operation state (1) of during a voltage raising period;

FIG. 5 shows the DC-AC converter of FIG. 3 in operation state (2) during the voltage raising period;

FIG. 6 shows the DC-AC converter of FIG. 3 in operation state (3) during the voltage raising period;

FIG. 7 shows the DC-AC converter of FIG. 3 in operation state (4) during the voltage raising period;

FIG. 8 shows the DC-AC converter of FIG. 3 in operation state (5) during the voltage raising period;

FIG. 9 shows the DC-AC converter of FIG. 3 in operation state (6) during the voltage raising period;

FIG. 10 shows the DC-AC converter of FIG. 3 in operation state (7) of during a voltage lowering period;

FIG. 11 shows the DC-AC converter of FIG. 3 in operation state (8) during the voltage lowering period;

FIG. 12 shows the DC-AC converter of FIG. 3 in operation state (9) during the voltage lowering period;

FIG. 13 shows the DC-AC converter of FIG. 3 in operation state (10) during the voltage lowering period;

FIG. 14 shows the DC-AC converter of FIG. 3 in operation state (11) during the voltage lowering period;

FIG. 15 shows the DC-AC converter of FIG. 3 in operation state (12) during the voltage lowering period;

FIG. 16 shows the DC-AC converter of FIG. 3 in operation state (13) during the voltage lowering period;

FIG. 17 shows the DC-AC converter of FIG. 3 in operation state (14) during the voltage lowering period;

FIG. 18 is a schematic circuit block diagram of a first modification of the DC-AC converter;

FIG. 19 is a schematic circuit block diagram of a second modification of the DC-AC converter;

FIG. 20 is a schematic circuit block diagram of a third modification of the DC-AC converter; and

FIG. 21 is a schematic circuit block diagram of a fourth modification of the DC-AC converter.

### DETAILED DESCRIPTION OF THE PREFERRED EMBODIMENTS

In the drawings, like numerals are used for like elements throughout.

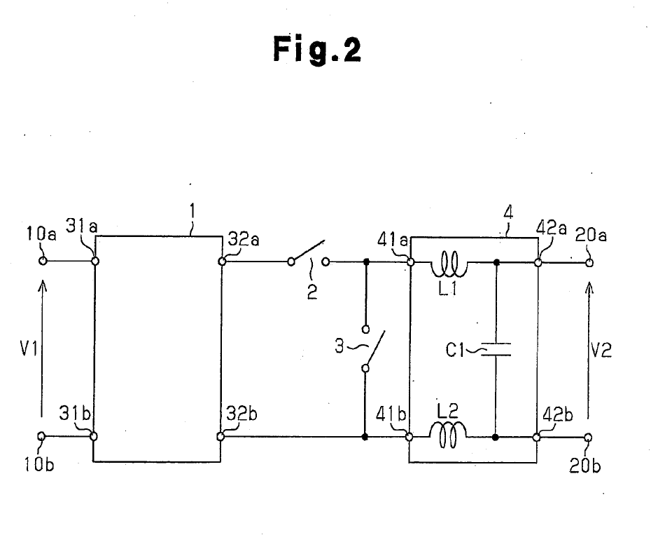

A DC-AC converter according to a preferred embodiment of the present invention will now be described in detail with reference to FIGS. 2 to 21.

FIG. 2 shows the principle of the DC-AC converter driven be the method of the present invention. In this DC-AC converter, DC voltage V1 is input to DC input terminals 10a and 10b, and AC voltage V2 is output from AC output terminals 20a and 20b. The DC input terminals 10a and 10b are connected to input terminals 31a and 31b of a voltage conversion circuit 1. One of the output terminals 32a and 32b of the voltage conversion circuit 1 is connected to one of the input terminals 41a and 41b of a filter circuit 4 via a first switch 2 (first switch circuit). The other one of the output terminals 32a and 32b of the voltage conversion circuit 1 is directly connected to the other one of the input terminals 41a and 41b of the filter circuit 4. A second switch 3 (second switch circuit) is connected between the input terminals 41a and 41b of the filter circuit 4. Output terminals 42a and 42b of the filter circuit 4 are connected to the AC output terminals 20a and 20b.

In the voltage conversion circuit 1, the input terminals 31a and 31b are insulated from the output terminals 32a and 32b. Accordingly, direct current does not flow from the input terminals 31a and 31b to the output terminals 32a and 32b. The voltage conversion circuit 1 converts the DC voltage V1 applied to the input terminals 31a and 31b to voltage having a polarity determined in accordance with the polarity of the AC voltage V2 and outputs the converted voltage from the output terminals 32a and 32b.

The filter circuit 4 is a typical filter having a coil L1 connected between the input terminal 41a and the output terminal 42a, a coil L2 connected between the input terminal 41b and the output terminal 42b, and an output capacitor C1 connected between the output terminals 42a and 42b.

When the first switch 2 is activated, the voltage at the output terminals 32a and 32b of the voltage conversion circuit 1 is applied to the input terminals 41a and 41b of the filter circuit 4. When the second switch 3 is activated, the voltage at the output terminals 32a and 32b of the voltage conversion circuit 1 is not applied to the input terminals 41a and 41b of the filter circuit 4. In this case, a current flow path is formed in the filter circuit 4. The filter circuit 4 smoothes the voltage applied to the input terminals 41a and 41b and outputs the smoothed voltage from the output terminals 42a and 42b. The voltage at the output terminals 42a and 42b of the filter circuit 4 is controlled by adjusting the ratio of the period during which the first switch 2 is activated and the period during which the second switch 3 is activated. The polarity of the voltage at the output terminals 42a and 42b of the filter circuit 4 is controlled by changing the polarity of the voltage output from the output terminals 32a and 32b of the voltage conversion circuit 1.

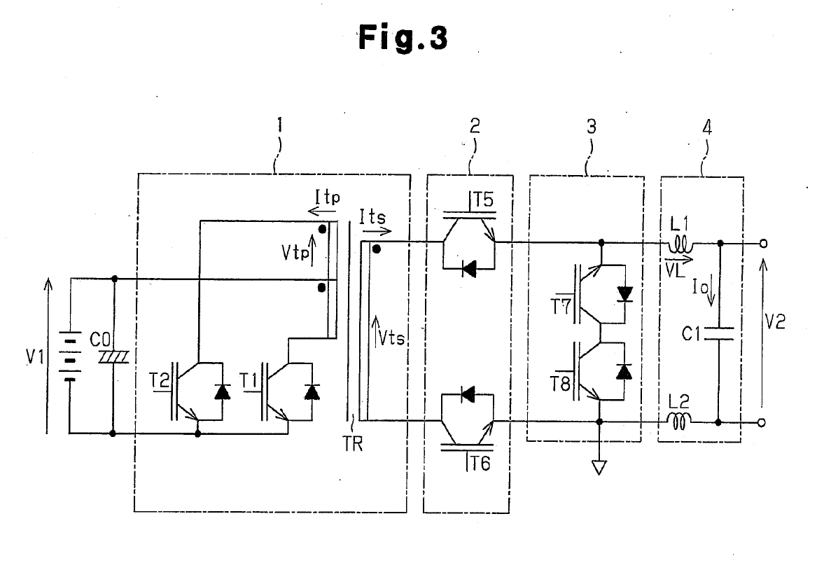

FIG. 3 is a block circuit diagram of the DC-AC converter according to the preferred embodiment of the present invention. The voltage conversion circuit 1 includes a transformer TR, which includes a primary winding, a secondary winding, and insulated gate bipolar transistor (IGBT) elements T1 and T2. The primary winding of the transformer TR includes first and second windings and a center tap connecting the first and second windings. The IGBT elements T1 and T2 each include an anti-parallel diode. The IGBT elements T1 and T2 have emitter terminals that are connected to each other. The IGBT element T1 has a collector terminal connected to one terminal of the first winding in the primary winding. The IGBT element T2 has a collector terminal connected to one terminal of the second winding in the primary winding. The center tap connects the other terminal of the first winding and the other terminal of the second winding. A smoothing capacitor C0 is connected between the emitter terminals of the IGBT elements T1 and T2 and the center tap of the transformer TR. The DC voltage V1 is supplied to the emitter terminals of the IGBT elements T1 and T2 that function as a negative side. The IGBT elements T1 and T2 form a push-pull circuit serving as a switching circuit.

An IGBT element T5 has a collector terminal connected to one terminal of the secondary winding of the transformer TR. An IGBT element T6 has a collector terminal connected to the other terminal of the secondary winding of the transformer TR. The IGBT element T5 has an emitter terminal connected to one terminal of the coil L1 of the filter circuit 4. The IGBT element T6 has an emitter terminal connected to one terminal of the coil L2 of the filter circuit 4. The IGBT elements T5 and T6 form the first switch 2. Each of the IGBT elements T5 and T6 is a semiconductor switching element having an anti-parallel diode. The first switch 2 maintains a non-conducting state between the output terminals 32a and 32b of the voltage conversion circuit 1 and the input terminals 41a and 41b of the filter circuit 4 regardless of the polarity of the voltage at the output terminals 32a and 32b of the voltage conversion circuit 1.

An emitter terminal of an IGBT element T7 is connected to a path connecting the emitter terminal of the IGBT element T5 and one terminal of the coil L1. An emitter terminal of an IGBT element T8 is connected to a path connecting the emitter terminal of the IGBT element T6 and the terminal of the coil L2. The IGBT elements T7 and T8 are connected in series with their collector terminals being connected to each other. The IGBT elements T7 and T8 form the second switch 3. Each of the IGBT elements T7 and T8 is a semiconductor switching element having an anti-parallel diode. The second switch 3 maintains a non-conducting state between the input terminals 41a and 41b of the filter circuit 4.

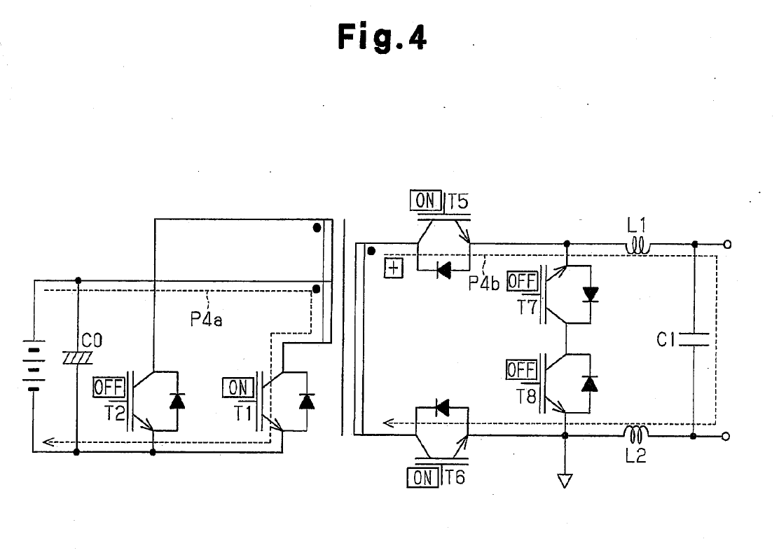

The method for driving the DC-AC converter of the preferred embodiment (FIG. 3) will now be described stage-by-stage with reference to FIGS. 4 to 17. The DC-AC converter generates the AC voltage V2 by switching the IGBT elements T1, T2, T5, T6, T7, and T8 at a frequency that is sufficiently higher than the frequency of the AC voltage V2 and controlling the on duty of the IGBT elements T1, T2, T5, and T6.

The circuit operation of the DC-AC converter during a voltage raising period of the AC voltage V2 will first be described with reference to FIGS. 4 to 9. The operation of the switching control performed with the IGBT elements T1, T2, and T5 to T8 during a single cycle is shown stage-by-stage in FIGS. 4 to 9.

In operation state (1) shown in FIG. 4, the IGBT element T1 is activated in a state in which the IGBT elements T5 and T6 are activated. This applies DC voltage V1 to the first winding of the primary winding via the center tap of the transformer TR. As indicated by the arrow P4a, current flows from the positive pole of the DC voltage V1 toward the negative pole of the DC voltage V1 via the center tap and the IGBT element T1. This current excites the transformer TR and induces voltage that causes the potential at a reference terminal of the secondary winding to be positive. As a result, current flows through a path extending from the reference terminal of the secondary winding through the IGBT element T5, the coil L1, the output capacitor C1 and/or a load (not shown), the coil L2, the anti-parallel diode of the IGBT element 6, and back to the secondary winding. This causes the AC voltage V2, which is the voltage at the terminals of the output capacitor C1, to rise as time elapses.

In the voltage raising period of the AC voltage V2, operation state (1) shown in FIG. 4 occupies a large portion of the operation period in the single cycle shown in FIGS. 4 to 9.

The IGBT elements T5 and T6 are activated before the IGBT element T1 is activated. Thus, no turn-on loss is generated when current starts flowing from the transformer TR through the coils L1 and L2.

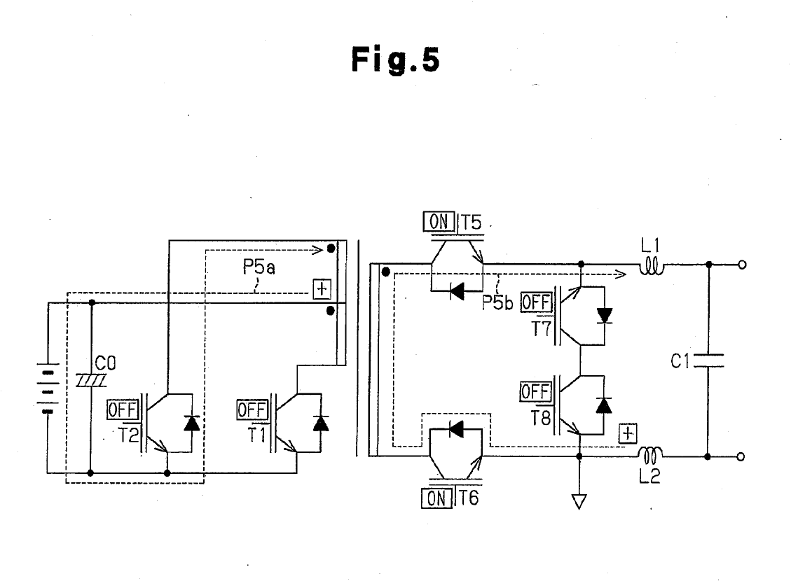

In operation state (2) shown in FIG. 5, the IGBT element T1 is deactivated. As a result, the continuity of the excitation current of the transformer TR causes current to flow through a path extending from the center tap of the transformer TR through the power supply of the DC voltage V1, the anti-parallel diode of the IGBT element T2, and back to the primary winding as indicated by the arrow P5a.

At the same time, the continuity of the current flowing through the coils L1 and L2 causes current to flow through a closed circuit formed by the coil L2, the anti-parallel diode of the IGBT element T6, the secondary winding of the transformer TR, the IGBT element T5, the coil L1, and the output capacitor C1 and/or the load (not shown) as indicated by the arrow P5b. Current superimposed on the current generated by the excitation energy of the transformer TR causes energy to accumulate in the coils L1 and L2. Current determined in accordance with the current generated by the accumulating energy flows through the primary winding of the transformer TR. This regenerates some of the energy accumulated in the coils L1 and L2 so that the energy is used as power for the DC voltage V1. The remaining energy accumulated in the coils L1 and L2 moves to the output capacitor C1. This continuously charges the output capacitor C1 and continuously raises the AC voltage V2.

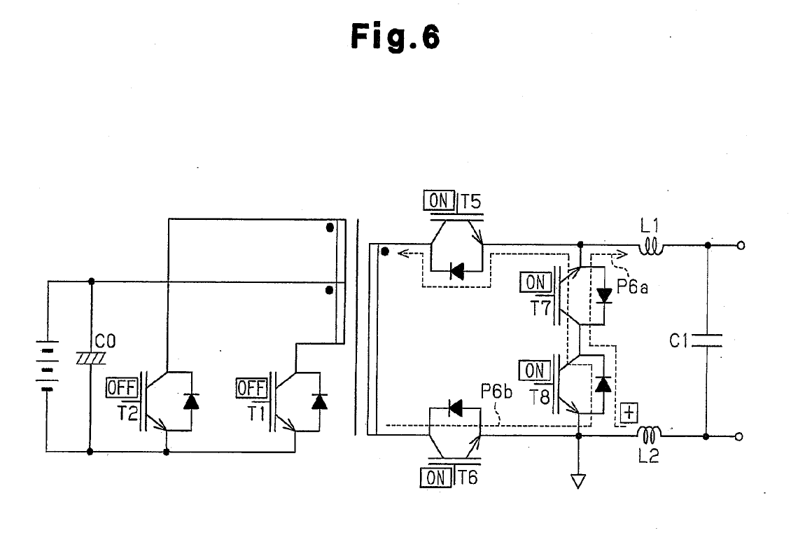

In operation state (3) shown in FIG. 6, the IGBT elements T7 and T8 are activated in a state in which the IGBT elements T5 and T6 are activated. As indicated by the arrow P6a, coil current continuously flows from the coil L2 to the coil L1 via the anti-parallel diode of the IGBT element T8 and the IGBT element T7. Some of the energy accumulated in the coils L1 and L2 sequentially moves to the output capacitor C1. This continuously charges the output capacitor C1 and continuously raises the AC voltage V2.

At the same time, the excitation current of the transformer TR flows through the secondary winding instead of the primary winding. More specifically, the excitation current of the transformer TR flows through a path extending from the IGBT element T6 through the anti-parallel diode of the IGBT element T8, the IGBT element T7, and the anti-parallel diode of the IGBT element T5, and back to the secondary winding as indicated by the arrow P6b. This is because the activation of the IGBT elements T7 and T8 short-circuits the secondary winding of the transformer TR.

When the IGBT element T8 is switched from a deactivated state to an activated state, the anti-parallel diode of the IGBT element T8 keeps the collector-emitter voltage of the IGBT element T8 substantially uniform. Thus, no switching loss occurs when the IGBT element T8 is activated.

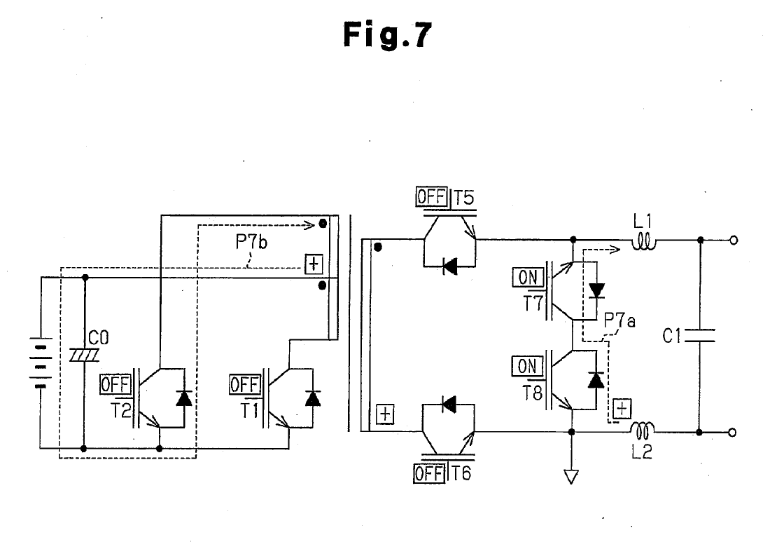

The DC-AC converter of the preferred embodiment maintains the continuity of the current flowing through the coils of the circuit in the operation states (2) and (3) shown in FIGS. 5 and 6, that is, during the shifting period from operation state (1) shown in FIG. 4 to operation state (4) shown in FIG. 7, which will be described later. It is preferred that the periods of operation states (2) and (3) be as short as possible.

In operation state (4) shown in FIG. 7, the IGBT elements T5 and T6 are deactivated in a state the IGBT elements T7 and T8 are activated. As indicated by the arrow P7a, the current flowing through the coils L1 and L2 continuously flows through a closed circuit formed by the coil L1, the output capacitor C1 and/or the load (not shown), the coil L2, the anti-parallel diode of the IGBT element T8, and the IGBT element T7. This continuously charges the output capacitor C1 and continuously raises the AC voltage V2.

In this state, the current generated by the excitation energy of the transformer TR flows through a closed circuit extending from the center tap of the primary winding through the power supply of the DC voltage V1 and the anti-parallel diode of the IGBT element T2 and back to the primary winding. The transformer TR is reset when there is no current generated by the excitation energy.

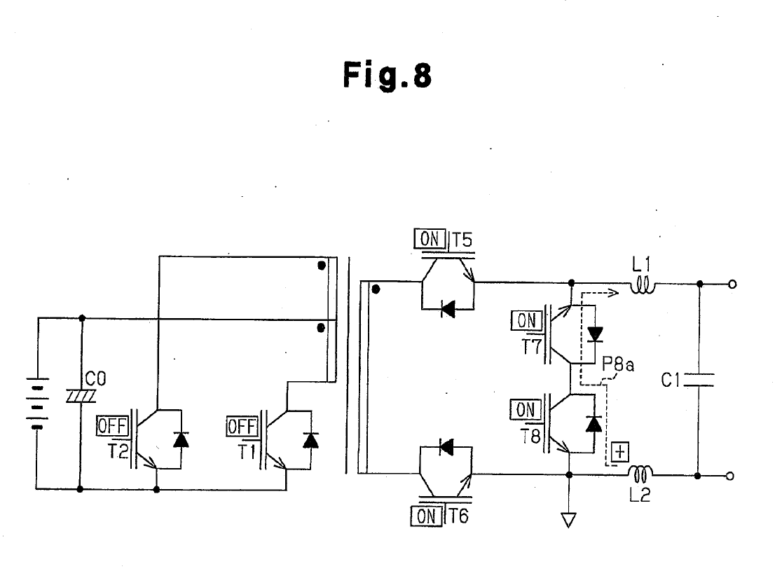

Although not shown in the drawings, the IGBT element T2 may be activated after the IGBT elements T5 and T6 are deactivated in operation state (4) shown in FIG. 7 and until the IGBT elements T5 and T6 are activated in operation state (5) shown in FIG. 8. In this case, voltage is applied to the primary winding of the transformer TR in a direction inverted from the direction in which voltage is applied to the primary winding in operation state (1) of FIG. 4. This enables acceleration of the resetting of the transformer TR.

In operation state (5) shown in FIG. 8, the IGBT elements T5 and T6 are activated in a state in which the IGBT elements T7 and T8 are activated. As indicated by the arrow P8a, the current flowing through the coils L1 and L2 continuously flows through the closed circuit formed by the coil L1, the output capacitor C1 and/or the load (not shown), the coil L2, the anti-parallel diode of the IGBT element T8, and the IGBT element T7. This continuously charges the output capacitor C1 and continuously raises the AC voltage V2.

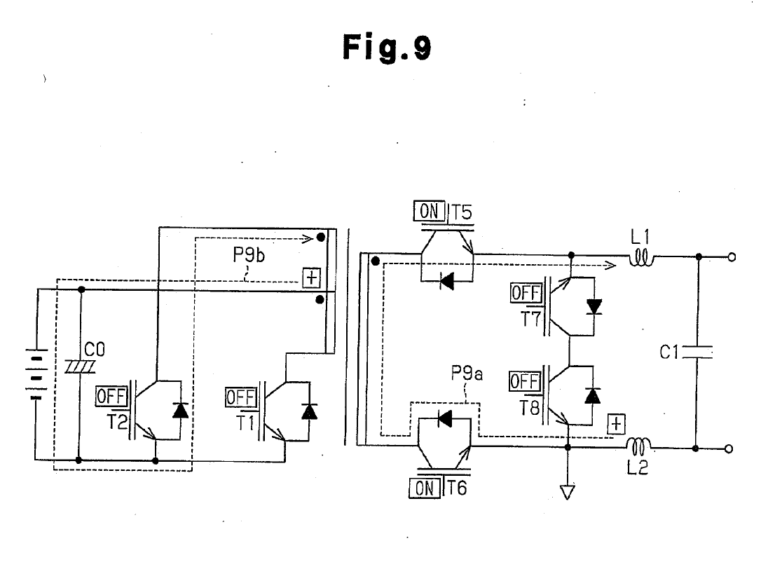

In operation state (6) shown in FIG. 9, the IGBT elements T7 and T8 are deactivated in a state in which the IGBT elements T5 and T6 are activated. As indicated by the arrow P9a, the current flowing through the coils L1 and L2 continuously flows through the closed circuit formed by the coil L2, the anti-parallel diode of the IGBT element T6, the secondary winding of the transformer TR, the IGBT element T5, the coil L1, and the output capacitor C1 and/or the load (not shown). This continuously charges the output capacitor C1 and continuously raises the AC voltage V2.

When the IGBT element T8 is switched from the activated state to the deactivated state, the collector-emitter voltage of the IGBT element T8 remains unchanged. This is because the anti-parallel diode of the IGBT element T8 is maintained in the activated state. Thus, no switching loss occurs when the IGBT element T8 is deactivated.

Afterwards, the IGBT element T1 is activated. This causes the DC-AC converter to shift from operation state (6) shown in FIG. 9 to operation state (1) shown in FIG. 4. The DC-AC converter raises the AC voltage V2 by repeating the operation states (1) to (6) in this order. The degree by which the AC voltage V2 is raised is changed by adjusting the ratio of the period of operation state (1) shown in FIG. 4 and the period of operation state (4) shown in FIG. 7.

The DC-AC converter maintains the continuity of the current flowing through the coils of the circuit in operation states (5) and (6) shown in FIGS. 8 and 9, that is, during the state transition period from operation state (4) shown in FIG. 7 to operation state (1) shown in FIG. 4. It is preferred that the periods of operation states (5) and (6) be as short as possible.

In the voltage raising period of the AC voltage V2, the period of operation state (1) occupies a sufficiently large portion of a single cycle of the switching control performed with the IGBT elements T1, T2, and T5 to T8 as described above. This accumulates sufficient excitation energy in the coils L1 and L2. Thus, current flows through each of the coils L1 and L2 in the same direction in operation states (2) to (6) that follow operation state (1). This continuously charges the output capacitor C1.

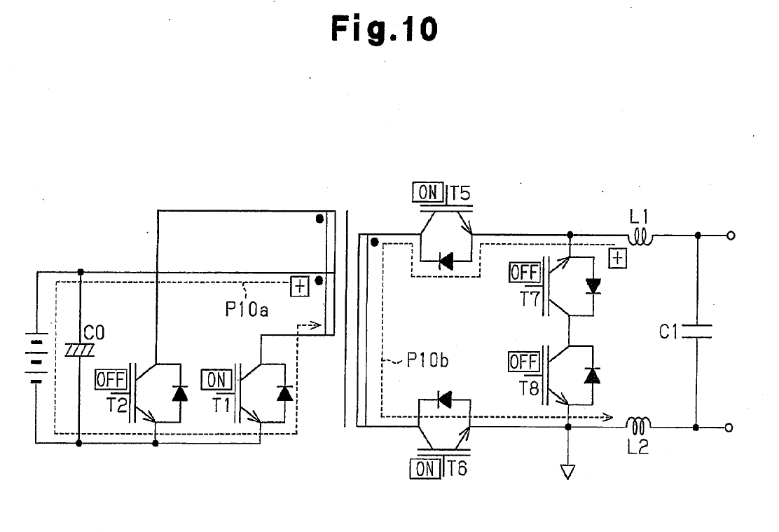

The circuit operation of the DC-AC converter in the voltage lowering period of the AC voltage V2 will now be described with reference to FIGS. 10 to 17. FIGS. 10 to 17 show the operations during a single cycle of the conduction control of the IGBT elements T1, T2, and T5 to T8 stage-by-stage. The output capacitor C1 is discharged and the AC voltage V2 is lowered by repeating this operation.

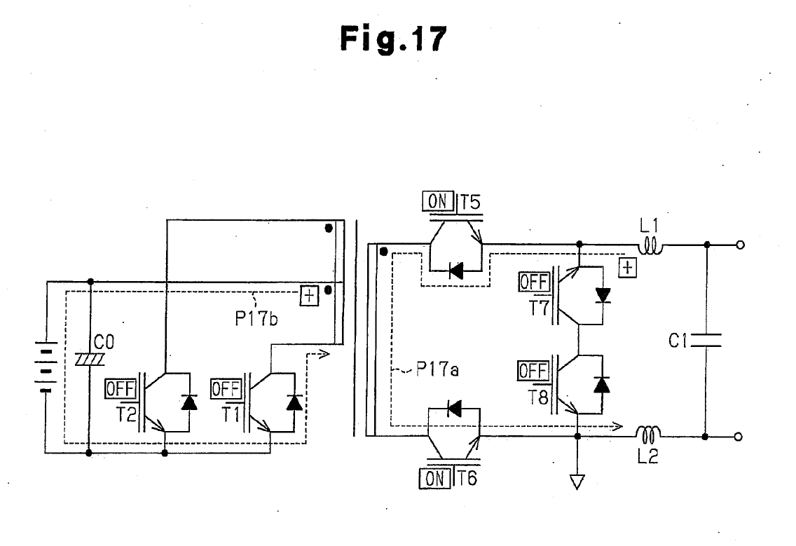

Operation state (14) shown in FIG. 17 is a state just before operation state (7) shown in FIG. 10. In operation state (14), the IGBT elements T5 and T6 are activated and the IGBT elements T1, T2, T7, and T8 are deactivated. As indicated by the arrow P17a, current flows from the output capacitor C1 through the coil L1, the anti-parallel diode of the IGBT element T5, the secondary winding of the transformer TR, the IGBT element T6, and back to the coil L2. As a result, the output capacitor C1 is discharged and the AC voltage V2 is lowered. The current from the output capacitor C1 excites the transformer TR. This generates voltage substantially equal to the DC voltage V1 in the primary winding of the transformer TR. As a result, current flows from the center tap of the transformer TR through the power supply of the DC voltage V1 and the anti-parallel diode of the IGBT element T1 as indicated by the arrow P17b. The discharging current of the output capacitor C1 corresponds to the sum of the excitation current of the transformer TR and the current at the primary side of the transformer TR.

Operation state (7) shown in FIG. 10 immediately follows operation state (14) in which the IGBT element T1 is activated. In operation state (7), the current flowing from the power supply of the DC voltage V1 toward the center tap of the transformer TR starts increasing in the primary winding of the transformer TR. In other words, the primary side current (indicated by the arrow P10a), which flows through the transformer TR immediately before the IGBT element T1 is activated, starts decreasing. This causes the current flowing from the secondary side reference terminal of the transformer TR toward the coil L1 to start increasing. In other words, the secondary side current (indicated by the arrow P10b) flowing through the transformer TR immediately before the IGBT element T1 is activated starts decreasing. This reduces the decrease of the voltage at the output capacitor C1.

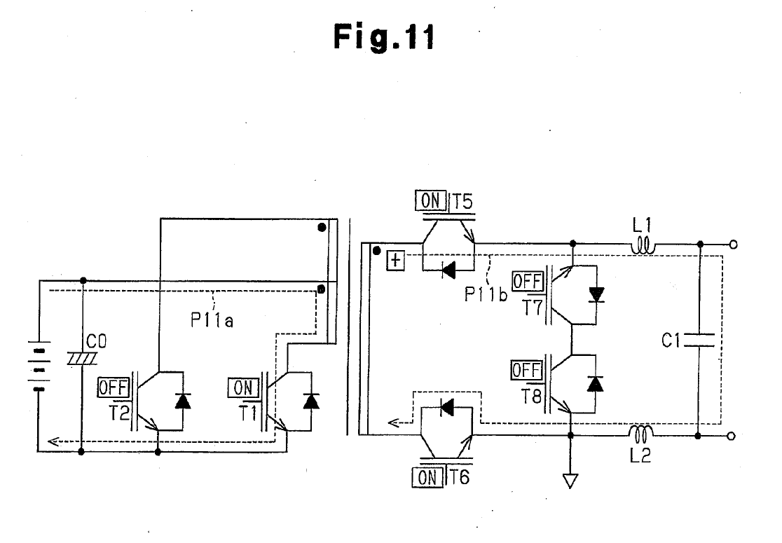

When the activated state of the IGBT element T1 continues, the primary side current and the secondary side current of the transformer TR both continuously increase in the direction described above. As a result, operation state (7) shifts to operation state (8) shown in FIG. 11. As indicated by the arrow P11a, the direction of the primary side current of the transformer TR changes to the direction from the power supply of the DC voltage V1 to the center tap of the transformer TR. In the same manner, the direction of the secondary current of the transformer TR also changes to the direction from the reference terminal of the transformer TR to the coil L1 as indicated by the arrow P11b. However, the directions of the currents may not be changed depending on the current value immediately before the IGBT element T1 is activated or the activation time of the IGBT element T1. The operation will be hereafter described assuming that the current directions have changed in the manner described above.

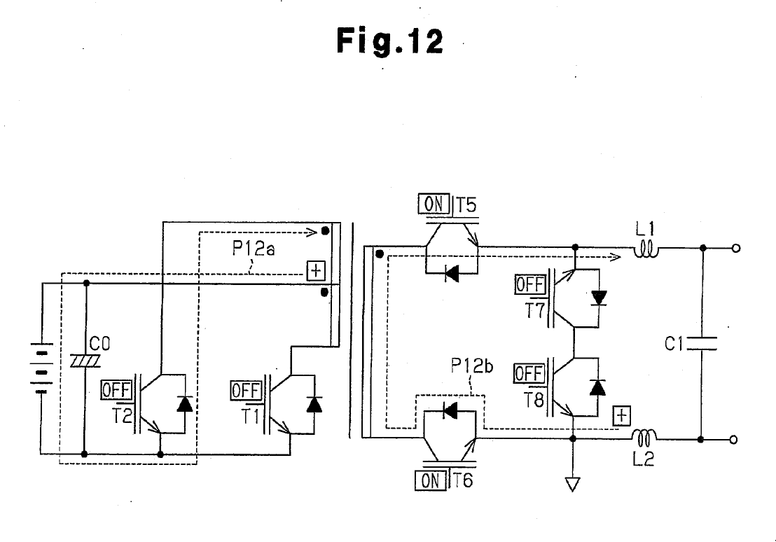

In operation state (9) shown in FIG. 12, the IGBT element T1 is deactivated. As a result, the continuity of the excitation current of the transformer TR causes excitation current to flow through a path from the center tap of the transformer TR through the power supply of the DC voltage V1, the anti-parallel diode of the IGBT element T2, and back to the primary winding as indicated by the arrow P12a.

At the same time, the continuity of the current flowing through the coils L1 and L2 causes current to flow through a closed circuit formed by the coil L2, the anti-parallel diode of the IGBT element T6, the secondary winding of the transformer TR, the IGBT element T5, the coil L1, and the output capacitor C1 and/or the load (not shown) as indicated by the arrow P12b. Current superimposed on the current generated by the excitation energy of the transformer TR causes energy to accumulate in the coils L1 and L2. Current determined in accordance with the current generated by the accumulating energy flows through the primary winding of the transformer TR. This regenerates some of the energy accumulated in the coils L1 and L2 so that the regenerated energy is used as the power supply for the DC voltage V1. The remaining energy accumulated in the coils L1 and L2 moves to the output capacitor C1. This continuously charges the output capacitor C1 and continuously raises the AC voltage V2.

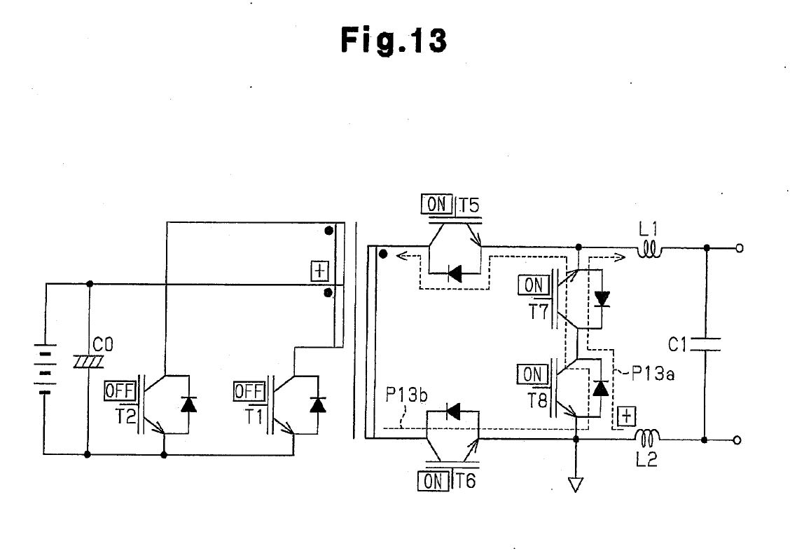

In operation state (10) shown in FIG. 13, the IGBT elements T7 and T8 are activated in a state in which the IGBT elements T5 and T6 are activated. As indicated by the arrow P13a, the coil current flowing from the coil L2 continuously flows to the coil L1 through the anti-parallel diode of the IGBT element T8 and the IGBT element T7. Some of the energy accumulated in the coils L1 and L2 sequentially moves to the output capacitor C1. This continuously charges the output capacitor C1 and continuously raises the AC voltage V2.

At the same time, the excitation current of the transformer TR flows through the secondary winding instead of the primary winding. More specifically, the excitation current of the transformer TR flows through a path extending from the IGBT element T6 through the anti-parallel diode of the IGBT element T8, the IGBT element T7, the anti-parallel diode of the IGBT element T5, and back to the secondary winding as indicated by the arrow P13b. This is because the activation of the IGBT elements T7 and T8 short-circuits the secondary winding of the transformer TR.

When the IGBT element T8 is switched from the deactivated state to the activated state, the collector-emitter voltage of the IGBT element T8 is maintained to be substantially constant by the anti-parallel diode of the IGBT element T8. Thus, no switching loss occurs when the IGBT element T8 is activated.

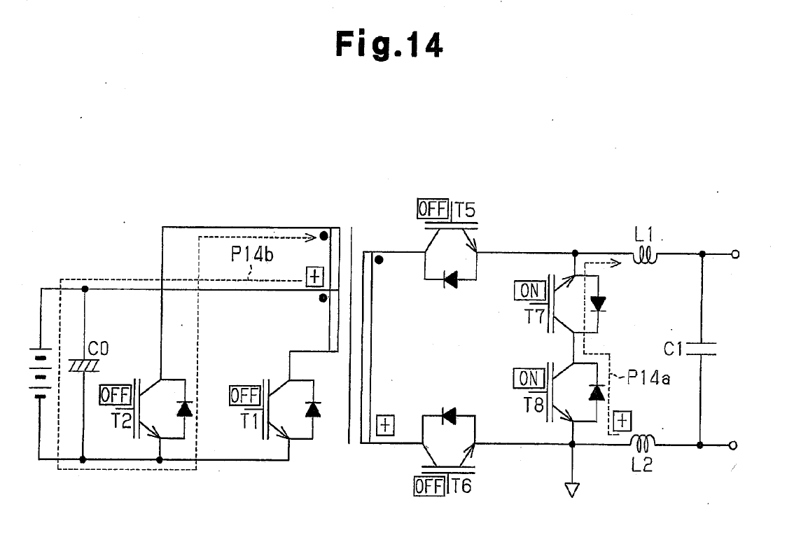

The DC-AC converter maintains the continuity of the current flowing through the coils of the circuit in operation states (9) and (10) shown in FIGS. 12 and 13, that is, in the state transition period from operation state (8) shown in FIG. 11 to operation state (11) shown in FIG. 14. It is preferred that the periods of operation states (9) and (10) be as short as possible.

In operation state (11) shown in FIG. 14, the IGBT elements T5 and T6 are deactivated in a state in which the IGBT elements T7 and T8 are activated. As indicated by the arrow P14a, the current flowing through the coils L1 and L2 continuously flows through a closed circuit formed by the coil L1, the output capacitor C1 and/or the load (not shown), the coil L2, the anti-parallel diode of the IGBT element T8, and the IGBT element T7. This continuously charges the output capacitor C1 and continuously raises the AC voltage V2.

The current generated by the excitation energy of the transformer TR flows through a closed circuit extending from the center tap of the primary winding through the power supply of the DC voltage V1, the anti-parallel diode of the IGBT element T2, and back to the primary winding as indicated by the arrow P14b. The transformer TR is reset when there is no current generated by the excitation energy.

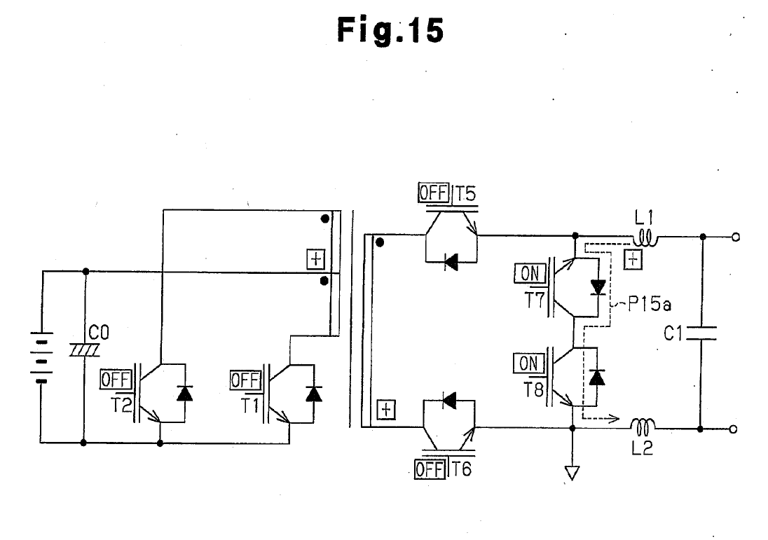

When the energy accumulated in the coils L1 and L2 is completely discharged, resonance of the output capacitor C1 and the coils L1 and L2 inverts the direction of the current flowing through the coils L1 and L2. Operation state (11) shown in FIG. 14 shifts to operation state (12) shown in FIG. 15. More specifically, current flows from the output capacitor C1 to the coil L2 via the coil L1, the anti-parallel diode of the IGBT element T7, and the IGBT element T8 as indicated by the arrow P15a in FIG. 15. As a result, the output capacitor C1 is discharged. This lowers the AC voltage V2. During the lowering period of the AC voltage V2, in accordance with the load, the period of operation state (11) shown in FIG. 14 is set to be longer than the period of operation state (8) shown in FIG. 11.

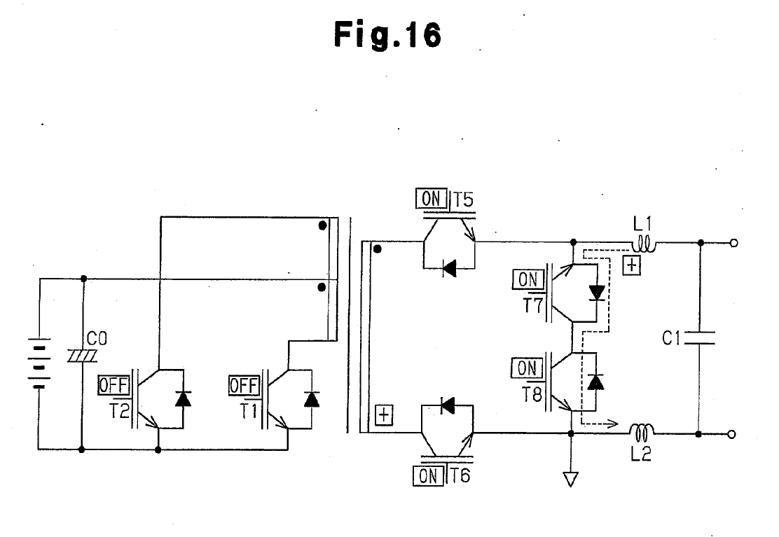

Although not shown in the drawings, the IGBT element T2 may be activated after the IGBT elements T5 and T6 are deactivated in operation state (11) shown in FIG. 14 and until the IGBT elements T5 and T6 are activated in operation state (13) shown in FIG. 16. In this case, voltage is applied to the primary winding of the transformer TR in a direction inverted from the direction in which voltage is applied to the primary winding in operation states (7) and (8) of FIGS. 10 and 11 This enables acceleration of the resetting of the transformer TR.

In operation state (13) shown in FIG. 16, the IGBT elements T5 and T6 are activated in a state the IGBT elements T7 and T8 are activated. This continuously discharges the output capacitor C1 and continuously lowers the AC voltage V2.

In operation state (14) shown in FIG. 17, the IGBT elements T7 and T8 are deactivated in a state in which the IGBT elements T5 and T6 are activated. The current flowing through the coils L1 and L2 continuously flows through the closed circuit formed by the coil L1, the anti-parallel diode of the IGBT element T5, the secondary winding of the transformer TR, the IGBT element T6, the coil L2, and the output capacitor C1 and/or the load (not shown). This continuously discharges the output capacitor C1 and continuously lowers the AC voltage V2.

When the IGBT element T7 is switched from the activated state to the deactivated state, the collector-emitter voltage of the IGBT element T7 does not change. This is because the anti-parallel diode of the IGBT element T7 is maintained in the activated state. Thus, no switching loss occurs during the switching control of the IGBT element T7.

Afterwards, the IGBT element T1 is activated. This shifts the DC-AC converter from operation state (14) shown in FIG. 17 to operation state (7) shown in FIG. 10. The DC-AC converter lowers the AC voltage V2 by repeating operation states (7) to (14) in this order. The degree by which the AC voltage V2 is lowered is changed by adjusting the ratio of the period of operation state (8) shown in FIG. 11 and the period of operation state (11) shown in FIG. 14.

The DC-AC converter maintains the continuity of the current flowing through the coils of the circuit in the operation states (13) and (14) of FIGS. 16 and 17, that is, during the state transition period from operation state (11) shown in FIG. 14 to operation state (7) shown in FIG. 10. It is preferred that the periods of operation states (13) and (14) be as short as possible.

In the voltage lowering period of the AC voltage V2, the periods of operation states (11) and (12) shown in FIGS. 14 and 15 occupy a significantly large percentage of a single cycle switching control of the IGBT elements T1, T2, and T5 to T8. The percentage is set in accordance with the load. This lowers the AC voltage V2.

The timing at which the direction of the coil current flowing through the IGBT elements T7 and T8 between the coils L1 and L2 is inverted from the direction in which the output capacitor C1 is charged with the current to the direction in which the output capacitor C1 is discharged is not limited to the timing of operation state (12) shown in FIG. 15. The direction of the coil current may be inverted at the timing in one of operation states (9) to (11) shown in FIGS. 12 to 14 in accordance with conditions such as time and circuit parameters in operation states (7) and (8) shown in FIGS. 10 and 11. Further, in operation state (8) shown in FIG. 11, the direction of the coil current may be maintained in the direction in which the output capacitor C1 is discharged. In this case, the output capacitor C1 is continuously discharged in all the periods shown in FIGS. 10 to 17, and the AC voltage V2 is continuously lowered.

As described above, the potential at the coil L1 of the output capacitor C1 becomes higher than the potential at the coil L2 of the output capacitor C1 when the IGBT element T1 is activated in the preferred embodiment. The IGBT element T2 may be switched instead of the IGBT element T1. In this case, the potential at the coil L2 of the output capacitor C1 becomes higher than the potential at the coil L1 of the output capacitor C1 when the IGBT element T2 is activated. This enables the AC voltage V2 to be generated.

Operation state (1) of FIG. 4 and operation state (7) of FIG. 10 correspond to a first sub-step for activating the IGBT elements T5 and T6, which are examples of the first switch 2.

Operation state (1) of FIG. 4, operation state (7) of FIG. 10, and operation state (8) of FIG. 11 correspond to a second sub-step for supplying converted voltage to the output terminals 32a and 32b from the input terminals 31a and 31b by activating the IGBT element T1 of the voltage conversion circuit 1 under a state in which the first switch 2 (IGBT elements T5 and T6) is activated.

Operation state (2) of FIG. 5 and operation state (9) of FIG. 12 correspond to a third sub-step for stopping the supply of converted voltage to the output terminals 32a and 32b from the input terminals 31a and 31b by the voltage conversion circuit 1 under a state in which the first switch 2 (IGBT elements T5 and T6) is activated.

Operation state (3) of FIG. 6 and operation state (10) of FIG. 13 correspond to a fourth sub-step for activating the IGBT elements T7 and T8, which are examples of the second switch 3, under a state in which the first switch 2 (IGBT elements T5 and T6) is activated.

Operation state (4) of FIG. 7, operation state (11) of FIG. 14, and operation state (12) of FIG. 15 correspond to a fifth sub-step for deactivating the first switch 2 (IGBT elements T5 and T6) under a state in which the second switch 3 (IGBT elements T7 and T8) is activated.

Operation state (5) of FIG. 8 and operation state (13) of FIG. 16 correspond to a sixth sub-step for activating the first switch 2 (IGBT elements T5 and T6) under a state in which the second switch 3 (IGBT elements T7 and T8) is activated.

Operation state (6) of FIG. 9 and operation state (14) of FIG. 17 correspond to a seventh sub-step for deactivating the second switch 3 (IGBT elements T7 and T8) under a state in which the first switch 2 (IGBT elements T5 and T6) is activated.

Return to operation state (1) of FIG. 4 from operation state (5) of FIG. 8 and operation state (6) of FIG. 9 corresponds to a step for repeating the first sub-step to the seventh sub-step. Further, return to operation state (7) of FIG. 10 from operation state (13) of FIG. 16 and operation state (14) of FIG. 17 corresponds to a step for repeating the first sub-step to the seventh sub-step.

Transition to operation state (4) of FIG. 7 via operation state (3) of FIG. 6 from operation state (2) of FIG. 5 corresponds to a step for deactivating the first switch 2 (IGBT elements T5 and T6) after stopping the supply of the converted voltage from the voltage conversion circuit 1. Further, transition to operation state (11) of FIG. 14 via operation state (10) of FIG. 13 from operation state (9) of FIG. 12 corresponds to a step for deactivating the first switch 2 (IGBT elements T5 and T6) after stopping the supply of the converted voltage from the voltage conversion circuit 1.

The method for driving the DC-AC converter of the preferred embodiment has the advantages described below.

The filter circuit 4 smoothes the voltage applied to the input terminals 41a and 41b and outputs the smoothed voltage from the output terminals 42a and 42b. The AC voltage V2 at the output terminals 42a and 42b of the filter circuit 4 is controlled by adjusting the ratio of the period during which power is supplied from the input terminals 31a and 31b to the output terminals 32a and 32b by the voltage conversion circuit 1 when the first switch 2 (the IGBT elements T5 and T6) is activated and the period during which the first switch 2 (the IGBT elements T5 and T6) is deactivated when the second switch 3 (IGBT elements T7 and T8) is activated.

The polarity of the AC voltage V2 at the output terminals 42a and 42b of the filter circuit 4 is controlled by changing the polarity of the voltage output to the output terminals 32a and 32b of the voltage conversion circuit 1.

The DC voltage V1 is directly converted to a desired AC voltage V2 while the input terminals 10a and 10b for direct current is insulated from the output terminals 20a and 20b for AC voltage.

The current generated by the excitation energy of the transformer TR flows through the closed circuit extending from the center tap of the primary winding through the power supply of the DC voltage V1, the anti-parallel diode of the IGBT element T2, and back to the primary winding. This regenerates the excitation energy of the transformer TR so that the regenerated energy is used as a power supply of the DC voltage V1. The transformer TR is reset when the regeneration operation is completed and there is no current generated by the excitation energy of the transformer TR.

The emitter terminals of the IGBT elements T5 and T7 each having the anti-parallel diode are connected to each other. The emitter terminals of the IGBT elements T6 and T8 each having the anti-parallel diode are connected to each other. Thus, the activation and deactivation of the first and second switches 2 and 3 are bi-directionally controllable regardless of the polarity of the voltage. Further, the reference potentials at the IGBT elements T5 and T7 may be equal to each other. The reference potentials at the IGBT elements T6 and T8 may be equal to each other. This enables the use of the same drive power supply. Accordingly, the switching control and the drive power supply are simplified.

It should be apparent to those skilled in the art that the present invention may be embodied in many other specific forms without departing from the spirit or scope of the invention. Particularly, it should be understood that the present invention may be embodied in the following forms.

The voltage conversion circuit 1 is not limited to the push-pull circuit formed by the transformer TR having the center tap included in the primary winding. Voltage conversion circuits according to other embodiments of the present invention will now be described.

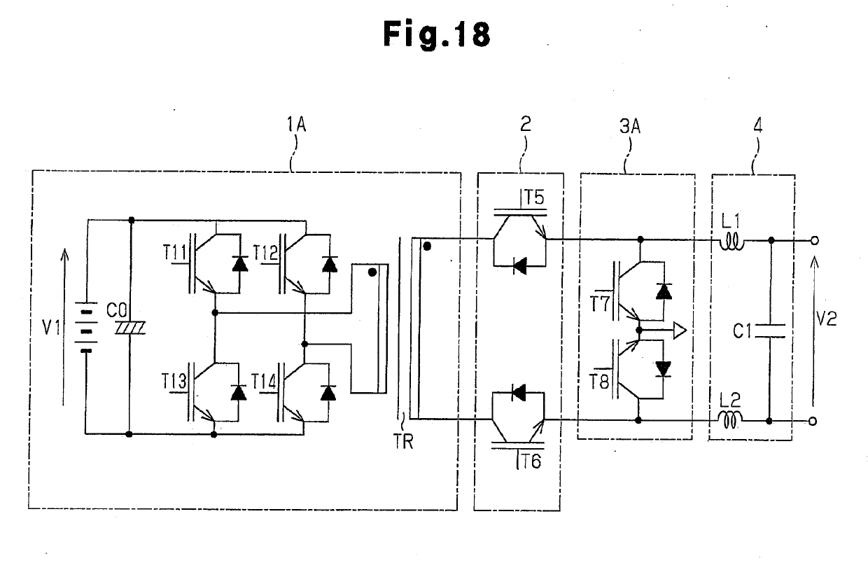

FIG. 18 is a circuit block diagram of a DC-AC converter according to a first modification of the present invention. A voltage conversion circuit 1A of the DC-AC rectifier includes a full-bridge circuit formed by IGBT elements T11 to T14.

A primary winding of a transformer TR has a terminal connected to a connecting point between an emitter terminal of the IGBT element T11 and a collector terminal of the IGBT element T13. The primary winding of the transformer TR has another terminal connected to a connecting point between an emitter terminal of the IGBT element T12 and a collector terminal of the IGBT element T14. Collector terminals of the IGBT elements T11 and T12 are connected to each other and to a positive pole of a power supply of a DC voltage V1. Emitter terminals of the IGBT elements T13 and T14 are connected to each other and to a negative pole of the power supply of the DC voltage V1. This forms the full-bridge circuit. The polarity of the voltage applied to the primary winding of the transformer TR is inverted by alternately activating the IGBT elements T11 and T14 and the IGBT elements T12 and T13.

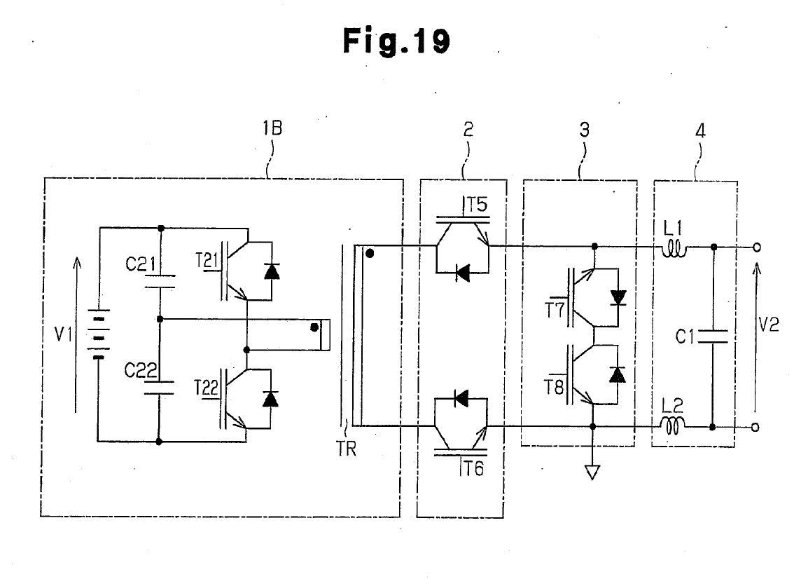

FIG. 19 is a circuit block diagram of a DC-AC converter according to a second modification of the present invention. A voltage conversion circuit 1B of the DC-AC converter includes a half-bridge circuit formed by IGBT elements T21 and T22 and capacitors C21 and C22.

A primary winding of a transformer TR has a terminal connected to a connecting point between the capacitors C21 and C22 that are connected in series. The primary winding of the transformer TR has another terminal connected to a connecting point between an emitter terminal of the IGBT element T21 and a collector terminal of the IGBT element T22 that are connected in series. The capacitors C21 and C22 are connected in series between a collector terminal of the IGBT elements T21 and an emitter terminal of the IGBT element T22. The collector terminal of the IGBT element T21 is connected to a positive pole of a power supply of the DC voltage V1. The emitter terminal of the IGBT element T22 is connected to a negative pole of the power supply of the DC voltage V1. This forms the half-bridge circuit. The polarity of the voltage applied to the primary winding of the transformer TR is inverted by alternately activating the IGBT element T21 and the IGBT element T22.

In the present invention, the collector terminals of the IGBT elements T7 and T8 do not have to be connected to each other. Further, the emitter terminals of the IGBT elements T5 and T7 do not have to be connected to each other. Moreover, the emitter terminals of the IGBT elements T6 and T8 do not have to be connected to each other. Other switch structures of the present invention will now be described.

The DC-AC converter of the first modification of the present invention shown in FIG. 18 includes a second switch 3A instead of the second switch 3 (FIG. 3). In the second switch 3A, emitter terminals of IGBT elements T7 and T8 are connected to each other. Thus, the activation and deactivation of the second switch 3A are bi-directionally controllable regardless of the polarity of the voltage. Further, anti-parallel diodes of the IGBT elements T7 and T8 face each other. This enables a path extending through the IGBT elements T7 and T8 to be non-conductive. Further, IGBT elements T5 and T6 of a first switch 2 and the IGBT elements T7 and T8 of the second switch 3A form a full-bridge circuit. This structure is preferable since a versatile full-bridge driver may be used to switch the IGBT elements T5, T6, T7, and T8. This structure is further preferable when the emitter terminals of the IGBT elements T7 and T8 are set at a ground potential as shown in FIG. 18.

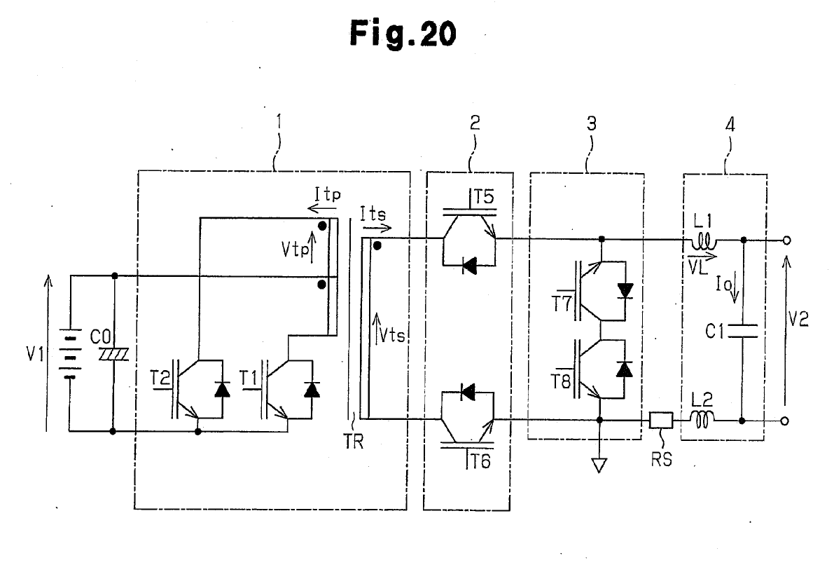

FIG. 20 is a circuit block diagram of a DC-AC converter according to a third modification of the present invention. The DC-AC converter is formed by adding a current sense resistor RS, which constantly detects coil current, to the structure of the DC-AC converter shown in FIG. 3. The current sense resistor RS is connected between a coil L2 and emitter terminals (ground potential) of IGBT elements T6 and T8 that are connected to ground.

The potential at the position of the current sense resistor RS is a reference potential used for the switching control. Thus, the potential is fixed. The operation state of the DC-AC converter does not greatly affect the potential. Thus, the current sense resistor RS enables subtle voltage to be easily detected from the current flowing through the current sense resistor RS.

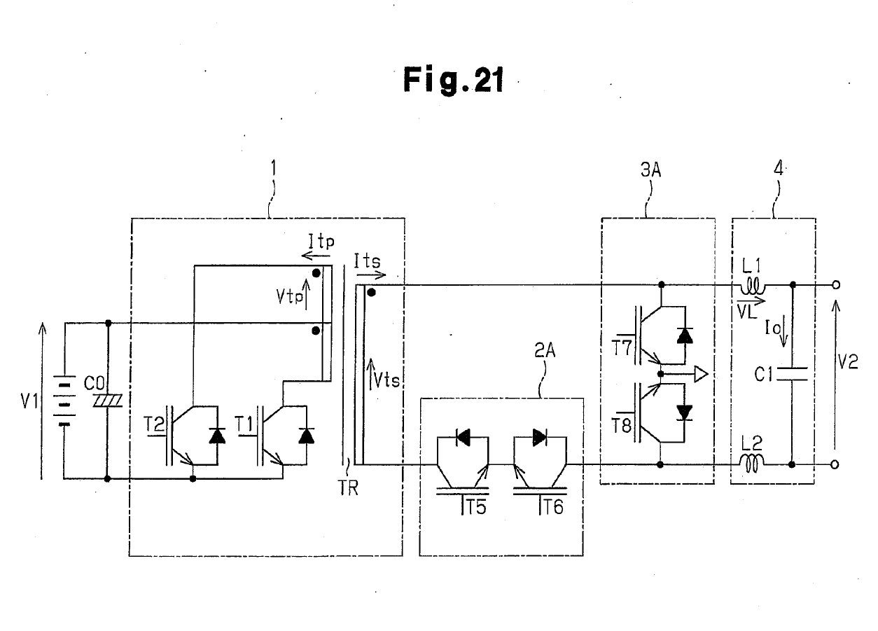

FIG. 21 is a circuit block diagram of a DC-AC converter according to a fourth modification of the present invention. The DC-AC converter includes first and second switches 2A and 3A instead of the first and second switches 2 and 3 included in the DC-AC converter shown in FIG. 3. A first switch 2 includes IGBT elements T5 and T6 connected in series with their emitter terminals connected to each other. The IGBT elements T5 and T6 are arranged between one terminal of a secondary winding of a transformer TR and a coil L2. The other terminal of the secondary winding of the transformer TR and a coil L1 are directly connected to each other. The emitter terminals of the IGBT elements T5 and T6 may be set at a common reference potential. This enables a common drive power supply to be used to switch the IGBT elements T5 and T6. Accordingly, the switching control and the drive power supply are simplified.

In the same manner, the second switch 3A includes IGBT elements T7 and T8 of which emitter terminals are connected to each other. This enables the use of a common drive power supply to switch the IGBT elements T7 and T8. Accordingly, the switching control and the drive power supply are simplified.

Further, the emitter terminals of the IGBT elements T7 and T8 are connected to ground. Thus, the drive power supply may be formed using the ground potential as its reference potential.

Instead of a bipolar transistor having an emitter terminal, collector terminal, and base terminal, the switching element of the present invention may be an MOS transistor having a source terminal, a drain terminal, and a gate terminal. In this case, the source terminal, the drain terminal, and the gate terminal of the MOS transistor correspond to the emitter terminal, the collector terminal, and the base terminal of the bipolar transistor, respectively.

The present examples and embodiments are to be considered as illustrative and not restrictive, and the invention is not to be limited to the details given herein, but may be modified within the scope and equivalence of the appended claims.

What is claimed:

1. A method for driving a DC-AC converter that converts DC voltage to AC voltage, wherein the DC-AC converter includes a voltage conversion circuit having a pair of first input terminals and a pair of first output terminals insulated from the pair of first input terminals, a filter circuit having a pair of second input terminals and a pair of second output terminals, a first switch circuit arranged between the pair of first output terminals and the pair of second input terminals for operably connecting the voltage conversion circuit and the filter circuit, and a second switch circuit arranged between the first switch circuit and the pair of second input terminals, the method comprising the steps of:
supplying the pair of first input terminals of the voltage conversion circuit with the DC voltage;
converting the DC voltage to voltage having a polarity corresponding to the AC voltage with the voltage conversion circuit under a state in which the first switch circuit is activated and supplying the converted voltage to the pair of first output terminals;
supplying the pair of second input terminals of the filter circuit with the converted voltage;
stopping the supply of the converted voltage from the voltage conversion circuit under a state in which the first switch circuit is activated; and
maintaining at least either one of the first switch circuit and the second switch circuit in an activated state so that the AC voltage is output from the pair of second output terminals of the filter circuit.

2. The method according to claim 1, further comprising the step of:
repeating the step of converting the DC voltage, the step of stopping the supply of the converted voltage, and the step of maintaining at least either one of the first switch circuit and the second switch circuit in an activated state.

3. The method according to claim 1, wherein:
the step of converting the DC voltage includes:
a first sub-step of activating the first switch circuit; and
a second sub-step of starting the supply of the converted voltage under a state in which the first switch circuit is activated;
the step of stopping the supply of the converted voltage includes:
a third sub-step of stopping the supply of the converted voltage under a state in which the first switch circuit is activated; and
the step of maintaining at least either one of the first switch circuit and the second switch circuit in an activated state includes:
a fourth sub-step of activating the second switch under a state in which the first switch circuit is activated;
a fifth sub-step of deactivating the first switch circuit under a state in which the second switch circuit is activated;
a sixth sub-step of activating the first switch circuit under a state in which the second switch circuit is activated; and
a seventh sub-step of deactivating the second switch circuit under a state in which the first switch circuit is activated;
the method further comprising the step of:
repeating the first sub-step to the seventh sub-step.

4. The method according to claim 3, wherein the voltage conversion circuit includes a transformer, the method further comprising the sub-step of:
applying voltage to the transformer in a direction inverted from a direction of voltage applied to the transformer by the second sub-step during a period between the fifth sub-step and the sixth sub-step.

5. The method according to claim 3, wherein the ratio of the period of the second sub-step and the period of the fifth sub-step is adjusted to control the AC voltage.
